(19) United States
(12) Patent Application Publication
(10) Pub. No.: US 2004/0177743 A1
(43) Pub. Date: Sep. 16, 2004

(54) Apparatus for mounting reed in wind instrument

(76) Inventor: Sung Im Jo, Seoul (KR)

Correspondence Address: LADAS & PARRY, 224 SOUTH MICHIGAN AVENUE, SUITE 1200, CHICAGO, IL, 60604, US

(21) Appl. No.: 10/734,970

(22) Filed: Dec. 15, 2003

(30) Foreign Application Priority Data
Dec. 17, 2002 (KR) KR20-2002-0037594

(51) Int. Cl. G10D 7/00

(52) U.S. Cl. 84/380 R

(57) ABSTRACT

An apparatus for mounting a reed in a wind instrument is described, in which a reed closely fixed to a mouth piece in various wind instruments is mounted in a point contact manner to minimize a contact area. As a result, an interference with respect to the reed is minimized during generation of instrumental sounds, to thereby induce a maximized resonance. The reed mounting apparatus closely fixes a reed which is a vibrator attached on one surface of a mouth piece provided in the upper end of various wind instruments, which includes a lower support plate having a central hole through which a screw bolt is engaged movably up and down; a circular or polygonal support ring formed on the upper surface of the lower support plate and made of a thin metal material; and close adherence units which are formed with a predetermined gap on the inner circumferential surface of the support ring, and formed in the form of a sphere or a hemisphere having a predetermined diameter, in which the outer circumferential surfaces of the reed and the mouth piece contact the outer circumferential surface of the sphere formed by the spherically disposed close adherence units, to thereby minimize a contact area between the reed and the reed mounting apparatus. When a reed is closely fixed on a mouth piece, close adherence units are attached on the polygonal edges of a circular iron support ring with a predetermined gap. The mouth piece and the reed can be fixed by the close adherence units. Thus, a contact area between the reed mounting apparatus and the reed is minimized to thereby maximize a resonance effect of instrumental sounds. Also, four edges on a pressurized fixing plate for fixing the mouth piece and the reed thereon are protruded in the lower portion thereof. Accordingly, a close adherence area on the outer circumferential surface of the reed is minimized to thereby prevent an interference from occurring during generation of the instrumental sounds and thus maximize generation of original sounds.

### BACKGROUND OF THE INVENTION

1. Field of the Invention

The present invention relates to an apparatus for mounting a reed in a wind instrument, and more particularly, to a reed mounting apparatus in which a reed closely fixed to a mouth piece in various wind instruments is mounted in a point contact manner to minimize a contact area, to thereby maximize vibration of the reed during generation of instrumental sounds, and also an interference of the mouth piece which is a resonance body with respect to the reed is minimized to thereby induce a maximized resonance.

2. Description of the Related Art

As is well known, a reed is a sound generating body of aerial resonance instruments, and is formed of a thin piece which is made of bamboo, lumber and metal and attached to the instruments. A plurality of wind instruments generate instrumental sounds by vibration of a reed. There are two types of a reed such as a single reed and a double reed. The single reed is formed of a sheet of a flat, slippery thin piece which is chiefly made of metal and used for harmoniums, reed organs, accordions, harmonicas, and so on. Also, a single reed which is attached to a mouth piece of pipes, is called a reed pipe. The reed pipe is used for pipe organs, clarinets, saxophones, and so on. A double reed is formed in the form of lips by making the upper portion of a short cylinder which is chiefly made of stems of reeds cut thinly, and pressing the short cylinder at both sides of the cylinder to form a lip-shaped double reed. A user bites and blows a double reed between user's teeth, which is chiefly used with a double reed fitted with a mouth piece in a pipe such as oboes and fagots.

A structure of a double reed which is obtained by attaching a reed to a mouth piece is shown in FIG. 1. Referring to FIG. 1, all wind instruments are different in view of shapes of a lower body 6 and an upper body 4, but are same in view of shapes of a mouth piece 8 and a reed 10 which are formed in the end of the upper body 4. Only a reed 10 is discriminated as a single reed or a double reed.

The reed 10 is closely attached to the mouth piece 8 through a separate reed mounting apparatus 20. Here, the reed mounting apparatus 20 is inserted onto the outer circumstantial surface of the mouth piece 8 and the reed 10 and then fixed by a screw.

The reed mounting apparatus 20 will be described below in more detail with reference to FIGS. 2A and 2B.

Referring to FIGS. 2A and 2B, the reed mounting apparatus 20 has a cylindrical tunnel-shaped body 22. A lower support plate 24 is provided in the lowest portion of the body 22. The lower portion of the body 22 is welded on both the sides of the lower support plate 24.

A number of cut-out holes 30 are formed on the upper surface and the side surfaces of the body 22. The cut-out holes 30 minimize a contact area between the reed 10 and the reed mounting apparatus 20.

Also, a pressurized fixing plate 27 which moves up and down by a screw 26 to closely attach the reed 10 to the mouth piece 8 is formed on the upper surface of the lower support plate 24. A screw head 28 is formed in the lower end of the screw 26.

With the above-described structure, the reed 10 is closely adhered on the lower end or upper end of the mouth piece 8, and then the reed mounting apparatus 20 is fitted onto the outer circumstantial surface of the reed 10 and the mouth piece 8. If the screw head 28 is made to rotate in a predetermined direction at the state where the reed mounting apparatus 20 is fitted onto the outer circumstantial surface of the reed 10 and the mouth piece 8, the pressurized fixing plate 27 makes the reed 10 closely attached to the mouth piece 8 according to ascending of the screw 26, and the inner portion 32 of the reed mounting apparatus 20 is closely adhered to the reed 10 and the mouth piece 8.

As an interference of the reed 10 by the reed mounting apparatus 20 increases during generation of instrumental sounds in wind instruments, a factor of disturbing generation of instrumental sounds such as lowering of resonance increases. However, since the area of the reed mounting apparatus 20 which contacts the reed 10 in a surface-to-surface contact manner is large, in the case of the conventional reed mounting apparatus 20, an interference area is increased to accordingly make it difficult to generate original instrumental sounds.

### SUMMARY OF THE INVENTION

To solve the above problems, it is an object of the present invention to provide an apparatus for mounting a reed in a wind instrument in which a reed closely fixed to a mouth piece in various wind instruments is mounted in a point contact manner to minimize a contact area, to thereby minimize an interference with respect to the reed during generation of instrumental sounds, and to thus induce a maximized resonance.

To accomplish the above object of the present invention, there is provided a reed mounting apparatus which closely fixes a reed which is a vibrator attached on one surface of a mouth piece provided in the upper end of various wind instruments, the reed mounting apparatus comprising: a lower support plate having a central hole through which a screw bolt is engaged movably up and down; a circular or polygonal support ring formed on the upper surface of the lower support plate and made of a thin metal material; and close adherence units which are formed with a predetermined gap on the inner circumferential surface of the support ring, and formed in the form of a sphere or a hemisphere having a predetermined diameter, in which the outer circumferential surfaces of the reed and the mouth piece contact the outer circumferential surface of the sphere formed by the spherically disposed close adherence units, to thereby minimize a contact area between the reed and the reed mounting apparatus.

Preferably, the close adherence units are positioned in the inner angular portions of the polygonal support ring.

More preferably, an insertion hole is formed in the end of the screw bolt, and a spherical or hemispherical rubber protrusion inserted into the insertion hole contacts the reed and the mouth piece.

Preferably, the reed mounting apparatus in a wind instrument further comprises a pressurized fixing plate which is made of a spherical or hemispherical metal piece combined with the end of the screw bolt, so as to contact the outer circumstantial surface of the reed in a point contact manner, and four edges of the metal piece are made to protrude in the lower portion of the metal piece so that a contact area contacting the reed can be minimized.

### BRIEF DESCRIPTION OF THE DRAWINGS

The above and other objects and advantages of the present invention will become more apparent by describing the preferred embodiments thereof in detail with reference to the accompanying drawings in which:

FIG. 1 is a perspective view showing a mounting process of a reed mounting apparatus for a wind instrument according to an embodiment of the present invention;

FIGS. 2A and 2B are a perspective view and a cross-sectional view, respectively showing a reed mounting apparatus for a wind instrument according to an embodiment of the present invention;

FIG. 3 is a perspective view showing a structure of a reed mounting apparatus for a wind instrument according to an embodiment of the present invention;

FIG. 4 is a front cross-sectional view showing a structure of a reed mounting apparatus for a wind instrument according to an embodiment of the present invention;

FIG. 5 is a cross-sectional view showing a structure of a reed mounting apparatus for a wind instrument according to another embodiment of the present invention; and

FIGS. 6A and 6B are a perspective view and a cross-sectional view, respectively showing a pressurized fixing plate in a reed mounting apparatus for a wind instrument according to another embodiment of the present invention.

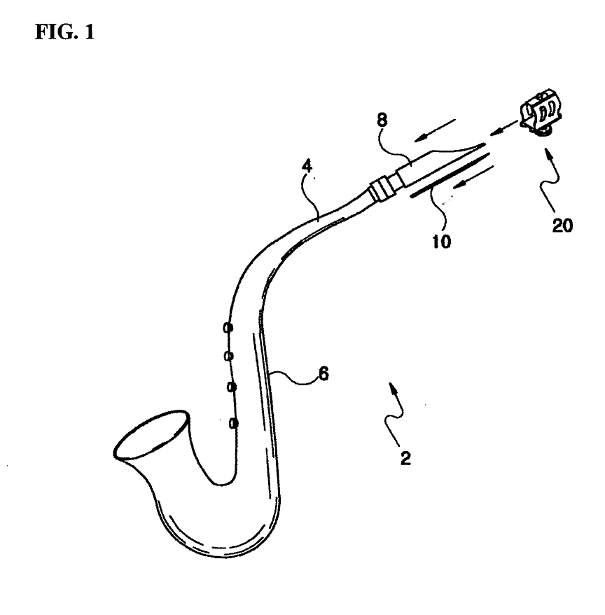

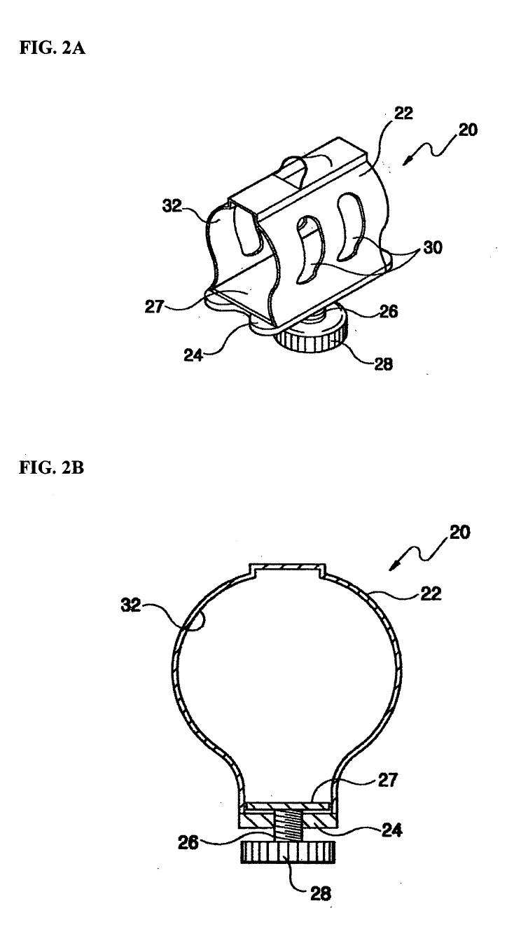

### DETAILED DESCRIPTION OF THE INVENTION

A reed mounting apparatus for wind instruments according to a preferred embodiment of the present invention will be described with reference to the accompanying drawings.

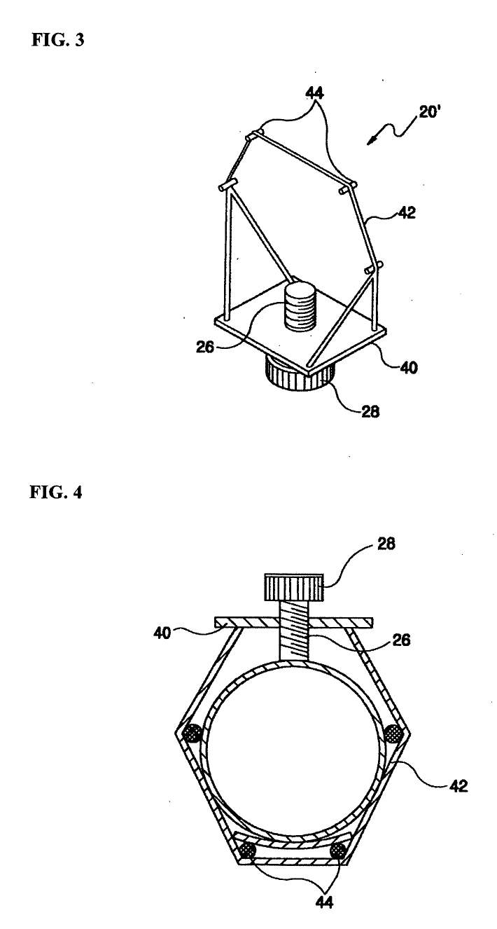

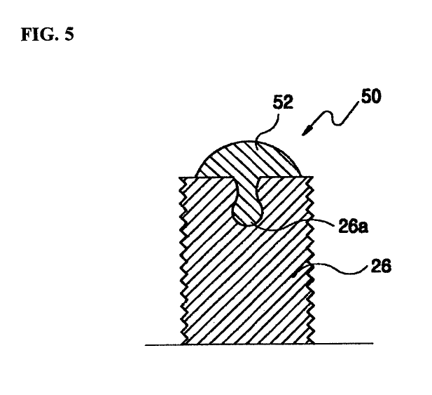

Referring to FIGS. 3 and 4, a reed mounting apparatus 20′ according to an embodiment of the present invention minimizes a contact area between the reed 10 and the reed mounting apparatus 20′ to prevent an interference of the reed mounting apparatus 20′ with respect to the reed 10, when the mouth piece 8 and the reed 10 in a wind instrument are closely fixed to each other. Also, the reed mounting apparatus 20′ is not made to contact the reed 10 in a surface-to-surface contact manner.

That is, the reed mounting apparatus 20′ according to the present invention is provided with a lower support plate 40 having a central hole through which a screw bolt 26 is engaged movably up and down. A screw head 28 is combined with the lower end of the screw bolt 26.

Also, a polygonal, preferably, hexagonal support ring 42 is combined on the upper surface of the lower support plate 40. A number of close adherence units 44 are attached spaced at a predetermined distance on the inner circumstantial surface of the support ring 42. Here, the close adherence units 44 are formed in the form of a small sized sphere or hemisphere. It is preferable that the close adherence units 44 are attached on the inner surfaces of the polygonal edges of the support ring 42. Preferably, four close adherence units 44 are attached on the support ring 42.

Thus, in the reed mounting apparatus 20′ having the above-described structure, the close adherence units 44 and the end of the screw bolt 26 contact the reed 10 and the mouth piece 8. Since the close adherence units 44 are formed of a cylinder, that is, a cylindrical rod, respectively, a circular arc portion, that is, the outer circumstantial portion of the cylinder contacts the outer circumstantial portions of the reed 10 and the mouth piece 8 in a point contact manner, to thereby minimize an interference during generation of the instrumental sounds.

FIG. 5 is a cross-sectional view showing a structure of a reed mounting apparatus for a wind instrument according to another embodiment of the present invention.

Referring to FIG. 5, when the close adherence units 44 and the end of the screw bolt 26 contact the reed 10 and the mouth piece 8, in the reed mounting apparatus 20′ having the above-described structure, the end of the screw bolt 26 may directly contact the reed 10 and the mouth piece 8. In this case, a contact area between the reed 10 and the reed mounting apparatus 20′ increases, and thus the reed 10 and the mouth piece 8 may be damaged by the end of the screw bolt 26.

Thus, in the present invention, an insertion hole 26a is formed in the end of the screw bolt 26, and the lower portion of a spherical or hemispherical rubber protrusion 50 is combined into the insertion hole 26a. Accordingly, since the uppermost contact 52 on the arc portion of the spherical or hemispherical rubber protrusion 50 contacts the reed 10 and the mouth piece 8, the contact area between the reed 10 and the reed mounting apparatus 20′ [symbol] be reduced. Also, the reed 10 and the mouth piece 8 can be prevented from being damaged by the end of the crew bolt 26.

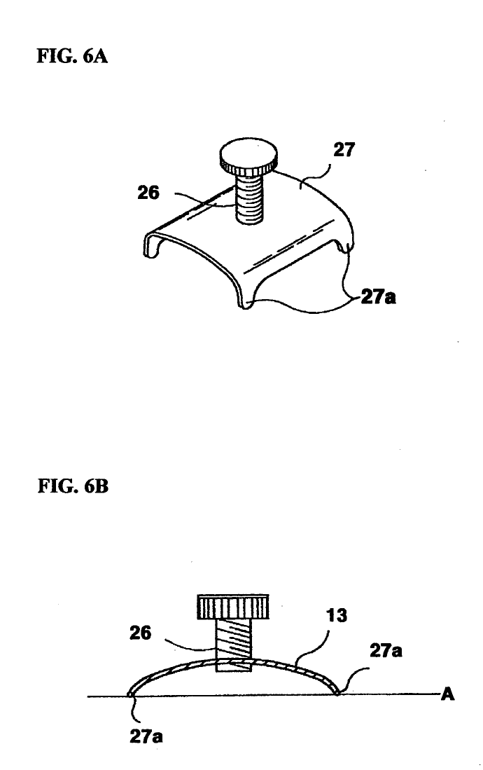

FIGS. 6A and 6B are a perspective view and a cross-sectional view, respectively showing a pressurized fixing plate in a reed mounting apparatus for a wind instrument according to another embodiment of the present invention.

Referring to FIGS. 6A and 6B, a pressurized fixing plate 27 is additionally attached to the end of a screw bolt 26 in a reed mounting apparatus for a wind instrument. When the pressurized fixing plate 27 presses the upper surface of the reed 10, the reed 10 closely adhered to the mouth piece 8. It is preferable that a contact area between the reed 10 and the pressurized fixing plate 27 is minimized, in order to minimize an interference during generation of original instrumental sounds.

Thus, in the reed mounting apparatus for a wind instrument according to another embodiment of the present invention, the pressurized fixing plate 27 is formed in the form of an arc, that is, rounded at the center of the plate. As a result, contacts 27a are protruded downwards at the four lower edges of the pressurized fixing plate 27, so that the contacts 27a contact the reed 10 in a point contact manner.

As shown in FIG. 6B, the pressurized fixing plate 27 contact a pressed surface “A” on the outer circumstantial surface of the reed 10 in a point contact manner through the contacts 27a. Thus, during generation of the instrumental sounds, an interference of the reed mounting apparatus with respect to the reed 10 can be minimized.

As described above, the present invention has been described with respect to particularly preferred embodiments. However, the present invention is not limited to the above embodiments, and it is possible for one who has an ordinary skill in the art to make various modifications and variations, without departing off the spirit of the present invention.

As described above, when a reed is closely fixed on a mouth piece, close adherence units are attached on the polygonal edges of a circular iron support ring with a predetermined gap. The mouth piece and the reed can be fixed by the close adherence units. Thus, a contact area between the reed mounting apparatus and the reed is minimized to thereby maximize a resonance effect of instrumental sounds. Also, four edges on a pressurized fixing plate for fixing the mouth piece and the reed thereon are protruded in the lower portion thereof. Accordingly, a close adherence area on the outer circumferential surface of the reed is minimized to thereby prevent an interference from occurring during generation of the instrumental sounds and thus maximize generation of original sounds.

What is claimed is:

1. A reed mounting apparatus which closely fixes a reed which is a vibrator attached on one surface of a mouth piece provided in the upper end of various wind instruments, the reed mounting apparatus comprising:
a lower support plate having a central hole through which a screw bolt is engaged movably up and down;
a circular or polygonal support ring formed on the upper surface of the lower support plate and made of a thin metal material; and
close adherence units which are formed with a predetermined gap on the inner circumferential surface of the support ring, and formed in the form of a sphere or a hemisphere having a predetermined diameter, in which the outer circumferential surfaces of the reed and the mouth piece contact the outer circumferential surface of the sphere formed by the spherically disposed close adherence units, to thereby minimize a contact area between the reed and the reed mounting apparatus.

2. The reed mounting apparatus of claim 1, wherein the close adherence units are positioned in the inner angular portions of the polygonal support ring.

3. The reed mounting apparatus of claim 1, wherein an insertion hole is formed in the end of the screw bolt, and a spherical or hemispherical rubber protrusion inserted into the insertion hole contacts the reed and the mouth piece.

4. The reed mounting apparatus of claim 1, further comprising a pressurized fixing plate which is made of a spherical or hemispherical metal piece combined with the end of the screw bolt, so as to contact the outer circumstantial surface of the reed in a point contact manner, and four edges of the metal piece are made to protrude in the lower portion of the metal piece so that a contact area contacting the reed can be minimized.
